(19) United States
(12) Patent Application Publication
(10) Pub. No.: US 2026/0058423 A1
(43) Pub. Date: Feb. 26, 2026

(54) INLET DEVICE FOR ELECTRIC VEHICLES

(71) Applicants: Hyundai Motor Company, Seoul (KR); Kia Corporation, Seoul (KR); KYUNGSHIN CO., LTD., Incheon (KR)

(72) Inventors: Yun Jae JUNG, Hwaseong-si (KR); Ju Yun PARK, Incheon (KR)

(73) Assignees: Hyundai Motor Company, Seoul (KR); Kia Corporation, Seoul (KR); KYUNGSHIN CO., LTD., Incheon (KR)

(21) Appl. No.: 19/253,357

(22) Filed: Jun. 27, 2025

(30) Foreign Application Priority Data
Aug. 20, 2024 (KR) 10-2024-0111354

(51) Int. Cl. H01R 29/00; B60L 53/10; B60L 53/16; H01R 13/502; H01R 13/52; H01R 13/639; H01R 13/66

(52) U.S. Cl. CPC H01R 29/00; B60L 53/16; H01R 13/502; H01R 13/5205; H01R 13/639; H01R 13/6683; B60L 53/11; H01R 13/5227; H01R 13/6691; H01R 2201/26

(57) ABSTRACT

An inlet apparatus for electric vehicles, to which a fast-charging or slow-charging connector is connected, may exhibit an effect of distributing fast/slow power without a fast/slow distribution junction block.

### CROSS-REFERENCE TO RELATED APPLICATIONS

The present application claims priority to Korean Patent Application No. 10-2024-0111354, filed on Aug. 20, 2024, the entire contents of which is incorporated herein for all purposes by this reference.

### BACKGROUND OF THE PRESENT DISCLOSURE

### Field of the Present Disclosure

The present disclosure relates to an inlet device for electric vehicles.

### Description of Related Art

In recent years, an electric vehicle that does not use a fossil fuel is being distributed to resolve environmental problems. The electric vehicle is driven by use of electricity charged to a battery.

The electricity is charged to the battery by coupling a charging connector to an inlet device of the vehicle for battery charging.

A typical method of charging the electric vehicle is classified into fast (DC) and slow (AC) charges. In the fast charge, the battery is charged through a high-voltage junction block, and in the slow charge, AC is converted into DC through ICCU or OBC and then the battery is charged.

In recent years, the north America determines a north American charging standard (NACS)-type charger as a standard charger. Since the NACS-type charger receives power for fast and slow-charging through one terminal, a fast/slow distribution junction block is additionally required.

When the fast/slow distribution junction block is applied, costs of a vehicle increases, a weight of the vehicle increases, and the number of processes increases. Thus, a measure for solving the above-described limitations is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an inlet device for electric vehicles, which includes a new structure of distributing fast/slow power without a fast/slow distribution junction block.

An exemplary embodiment of the present disclosure provides an inlet device for an electric vehicle, the inlet device including: a housing including a coupling portion to which a charging connector is coupled; a charging module including a pair of temperature sensors each connected to a sensor cable, a pair of terminal connection portions each connected to a fast charging cable and a slow charging cable, and a pair of charging terminals respectively connected to the pair of terminal connection portions and exposed through the coupling portion; a signal module including a plurality of signal terminals exposed through the coupling portion so that the vehicle exchanges signals with the charging connector; and a locking actuator configured to selectively lock the charging connector coupled to the coupling portion.

In an exemplary embodiment of the present disclosure, each of the pair of terminal connection portions may include: a fast charging terminal connected to the fast charging cable; and a slow charging terminal connected to the slow charging cable.

In an exemplary embodiment of the present disclosure, the fast charging cable may include a first welding portion fixed to the fast charging terminal by a ultrasonic welding process, and the slow charging cable may include a second welding portion fixed to the slow charging terminal by a ultrasonic welding process.

In an exemplary embodiment of the present disclosure, the inlet device may further include a voltage sensor disposed between the fast charging terminal and the slow charging terminal.

In an exemplary embodiment of the present disclosure, the fast charging terminal and the slow charging terminal may be coupled through a bolt.

In an exemplary embodiment of the present disclosure, the charging module may further include a pair of terminal holder covers respectively fixing the pair of fast charging terminals.

In an exemplary embodiment of the present disclosure, each of the pair of terminal holder covers may include: a first cover portion including a first installation hole, in which at least a portion of the charging terminal is provided, at one side of an internal surface in a longitudinal direction thereof and a second installation hole, in which at least a portion of the fast charging cable is provided, at the other side; and a second cover portion including a third installation hole, in which at least a portion of the charging terminal is provided, at one side of an internal surface in a longitudinal direction thereof and a fourth installation hole, in which at least a portion of the fast charging cable is provided, at the other side thereof.

In an exemplary embodiment of the present disclosure, the first cover portion may include a first support portion formed on a circumference of the first installation hole while protruding inward in a radial direction, a first stopper spaced apart from the first support portion in a longitudinal direction to support a rear portion of the terminal connection portion, and a first protruding portion configured to support a top surface of the terminal connection portion, and the second cover portion may include a second support portion formed on a circumference of the third installation hole while protruding inward in the radial direction, a second stopper spaced apart from the second support portion in the longitudinal direction to support the rear portion of the terminal connection portion, and a second protruding portion configured to support the top surface of the terminal connection portion.

In an exemplary embodiment of the present disclosure, each of the pair of terminal connection portions may include a stepped portion including a shape of a circle and protruding in the longitudinal direction to be accommodated on the first support portion, and each of the pair of charging terminal may protrude from the stepped portion in the longitudinal direction.

In an exemplary embodiment of the present disclosure, the first cover portion may further include a sensor fixing portion in which the temperature sensor is provided.

In an exemplary embodiment of the present disclosure, the sensor fixing portion may include a third protruding portion that protrudes from the internal surface of the first cover portion and includes a sensor fixing groove at a lower portion thereof.

In an exemplary embodiment of the present disclosure, the temperature sensor may be provided in the sensor fixing groove to contact with a top surface of the fast charging terminal and a side surface of the slow charging terminal.

In an exemplary embodiment of the present disclosure, the housing may include: a housing main body on which the charging module and the signal module are provided; a housing cover coupled to a rear portion of the housing main body; and a wire seal disposed between the housing main body and the housing cover.

In an exemplary embodiment of the present disclosure, the wire seal may include: a pair of first fast charging cable holes through which the fast charging cable passes; a pair of first slow charging cable holes through which the slow charging cable passes; and a first sensor cable hole through which the sensor cable passes.

In an exemplary embodiment of the present disclosure, the housing cover may include: a pair of second fast charging cable holes through which the fast charging cable passes; a pair of second slow charging cable holes through which the slow charging cable passes; and a second sensor cable hole through which the sensor cable passes.

In an exemplary embodiment of the present disclosure, the housing may include a locking actuator installation portion formed at a lower portion thereof, and the locking actuator installation portion may include a locking pole installation portion that communicates with the coupling portion.

In an exemplary embodiment of the present disclosure, the locking actuator installation portion may include: a drain seal formed at one side; and a drain seal cover that covers the drain seal.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an inlet device for electric vehicles according to an exemplary embodiment of the present disclosure.

FIG. 2 is an exploded view exemplarily illustrating a housing cover of the inlet device for electric vehicles according to an exemplary embodiment of the present disclosure.

FIG. 3 is a view exemplarily illustrating a charging module of the inlet device for electric vehicles according to an exemplary embodiment of the present disclosure.

FIG. 4 is an exploded view exemplarily illustrating the charging module of the inlet device for electric vehicles according to an exemplary embodiment of the present disclosure.

FIG. 5 is a view exemplarily illustrating a state in which a fast charging terminal is coupled to a first cover portion in the inlet device for electric vehicles according to an exemplary embodiment of the present disclosure.

FIG. 6 is a view exemplarily illustrating a state in which a slow charging terminal is coupled to the fast charging terminal in the inlet device for electric vehicles according to an exemplary embodiment of the present disclosure.

FIG. 7 is a view exemplarily illustrating the first cover portion of the inlet device for electric vehicles according to an exemplary embodiment of the present disclosure.

FIG. 8 is a view exemplarily illustrating a state in which a temperature sensor is coupled to the first cover portion in the inlet device for electric vehicles according to an exemplary embodiment of the present disclosure.

FIG. 9 is a cross-sectional view taken along line A-A of FIG. 3.

FIG. 10 is a cross-sectional view taken along line B-B of FIG. 3.

FIG. 11 is a view exemplarily illustrating a voltage sensor disposed between the fast charging terminal and the slow charging terminal in the inlet device for electric vehicles according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Since the present disclosure may have multiple modified embodiments, exemplary embodiments are illustrated in the drawings and are described in the detailed description of the present disclosure. However, this does not limit the present disclosure within the specific embodiments and it should be understood that the present disclosure covers all the modifications, equivalents, and replacements within the idea and technical scope of the present disclosure.

It will be understood that although the terms of “first” and “second” are used herein to describe various elements, these elements should not be limited by these terms. Terms are only used to distinguish one component from other components.

The term “and/or” is used to include all possible combinations of the listed items. For example, “A and/or B”includes all three cases of “A”, “B”, and “A and B”.

It will also be understood that when an element is referred to as being “‘connected to” or “engaged with” another element, it may be directly connected to the other element, or intervening elements may also be present. It will also be understood that when an element is referred to as being ‘directly connected to’ another element, there is no intervening elements.

In the description of embodiments, it will be understood that when a layer (or film), region, pattern or structure is referred to as being ‘on’ or ‘under’ another layer (or film), region, pad or pattern, the terminology of ‘on’ and ‘under’ includes both the meanings of ‘directly’ and ‘indirectly’. Although the terms “above/upper” or “below/lower” are used to indicate the relative positional relationship between components based on the appearance shown in the drawings for convenience, the terms do not limit the substantial positions of the components. For example, “B above A” simply indicates that B is illustrated above an in the drawing unless otherwise predetermined or unless A should be disposed above B due to properties of A and B. However, in a substantially realized product, B may be disposed below A, or B and A may be disposed at left and right sides.

In the drawings, the dimensions and size of each layer (or film), region, pattern or structure may be exaggerated, omitted, or schematically illustrated for convenience in description and clarity.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in an exemplary embodiment of the present disclosure are defined differently, the terms may be construed as meaning known to those skilled in the art. Terms such as terms that are generally used and have been in dictionaries should be construed as including meanings matched with contextual meanings in the art. In the present description, unless defined clearly, terms are not ideally, excessively construed as formal meanings.

Hereinafter, various exemplary embodiments included in the present specification is described with reference to the accompanying drawings, and the same or corresponding components are provided with the same drawing number regardless of reference number, and their duplicated description will be omitted.

An inlet device for electric vehicles according to at least an exemplary embodiment of the present disclosure includes a housing, a charging module 300, a signal module 190, and an actuator.

A housing 100 and 250 is provided in a vehicle and includes a coupling portion 110 to which a charging connector is connected. A bolt hole 120 is formed at each of both sides of the coupling portion 110 to fix the housing 100 and 250 to a vehicle body.

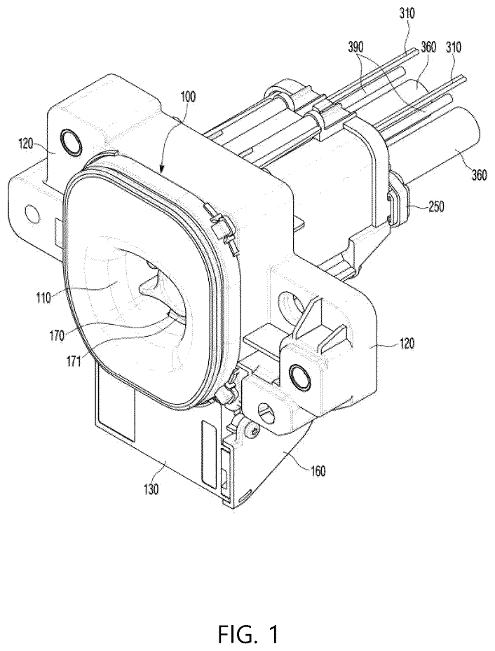

Referring to FIG. 1, the housing 100 and 250 includes a housing main body 100 in which the charging module 300 and the signal module 190 are provided.

An actuator installation portion 130 is formed below the housing main body 100.

The actuator installation portion 130 includes a locking pole installation portion 140 that communicates with the coupling portion 110. The locking pole installation portion 140 includes a shape of a rectangular through-hole. A direction of the through-hole of the locking pole installation portion 140 is perpendicular in a direction of the coupling portion 110. The locking pole installation portion 140 may be formed at an inlet side of the coupling portion 110.

Although the actuator installation portion 130 is formed below the housing main body 100 in the exemplary embodiment of the present disclosure, the exemplary embodiment of the present disclosure is not limited thereto. In an exemplary embodiment of the present disclosure, the actuator installation portion 130 may be provided above the housing or at one of left and right sides of the housing.

The actuator installation portion 130 includes a drain seal 150 formed at one side thereof. The drain seal 150 is configured to drain accumulated water from the housing to prevent a state in which the connector may not be coupled to the coupling portion 110 as water accumulated in the housing freezes due to temperature drop.

The actuator installation portion 130 includes a drain seal cover 160 that covers the drain seal 150.

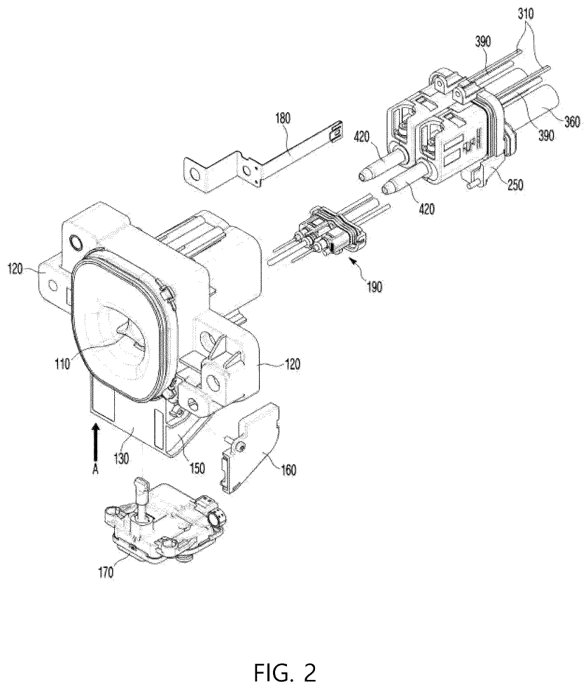

A locking actuator 170 is disposed on the above-described actuator installation portion 130. As illustrated in FIG. 2, the locking actuator 170 is coupled in an upward direction A from below the actuator installation portion 130.

The locking actuator 170 selectively locks the charging connector coupled to the coupling portion 110 by repeatedly moving a locking pole 171 through an electrical signal.

Although not shown in the drawings, the charging connector includes a locking pole groove formed on an external surface thereof.

The signal module 190 includes a plurality of signal terminals including at least a portion exposed in the coupling portion 110 so that the vehicle and the charging connector exchange signals with each other.

The signal terminal includes a control pilot (CP) circuit which is configured as a digital communication path between the charging system and the vehicle, a proximity pilot (PP) circuit that determines a state of the vehicle connector, and a ground (PE) circuit connected to the inlet shielding busbar 180 in FIG. 2 so that the vehicle body is grounded. The inlet shielding busbar 180 is disposed on an external surface of the housing.

The housing further includes a pair of wire seals 200 disposed between the housing body 100 and a housing cover 250 that will be described later. The pair of wire seals 200 may be made of an insulating rubber material.

The pair of wire seals 200 includes an effect of preventing water from being introduced through a pair of second slow charging cable holes 280 and a pair of second fast charging cable holes 270 formed in the above-described housing cover 250.

The pair of wire seals 200 are coupled to a fixing projection 260 that will be described later, and a plurality of fixing projection holes 210 are formed in the pair of wire seals 200.

One of the pair of wire seals 200 includes a first fast charging cable hole 220 through which a fast charging cable 360 axially passes. The first fast charging cable hole 220 is formed at the same position as the above-described second fast charging cable hole 270. The first fast charging cable hole 220 may have a diameter less than that of the first fast charging cable to prevent moisture introduction.

One of the pair of wire seals 200 further includes a first slow charging cable hole 230 through which a slow charging cable 390 axially passes. The first slow charging cable hole 230 is formed at the same position as the above-described second slow charging cable hole 280. The first slow charging cable hole 230 may have a diameter less than that of the first slow charging cable 390 to prevent moisture introduction.

One of the pair of wire seals 200 includes a first sensor slow charging cable hole 240 through which a sensor cable 310 passes in an axial direction thereof. The first sensor slow charging cable hole 240 may have a diameter less than that of the first sensor cable 310 to prevent moisture introduction.

The housing further includes the housing cover 250 which is coupled to a rear portion of the housing main body 100.

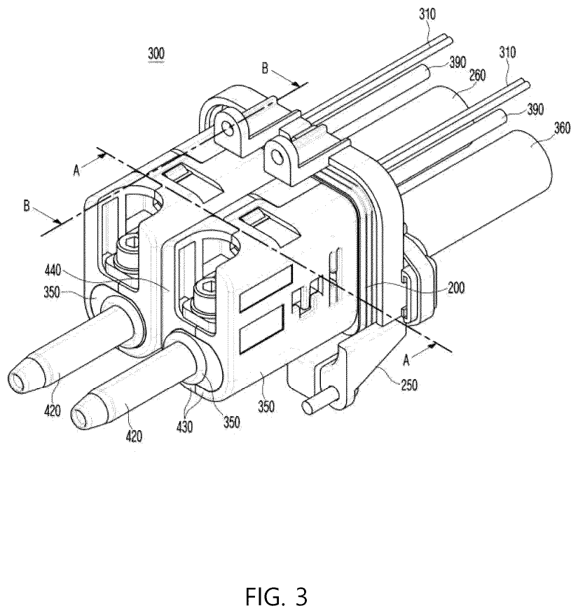

Referring to FIG. 3, the housing cover 250 includes a pair of second fast charging cable holes 270 through which the fast charging cable 360 axially passes.

The housing cover 250 further includes a pair of second slow charging cable holes 280 through which the pair of slow charging cables 390 axially pass. The pair of second slow charging cable holes 280 are formed above the pair of second fast charging cable holes 270.

The housing cover 250 includes a pair of second sensor cable holes 290 through which the pair of sensor cables 310 axially pass. The pair of second sensor cable holes 290 may be formed adjacent to the above-described second slow charging cable holes 280 so that a temperature sensor 320 that will be described later may be disposed adjacent to the slow charging terminal 390.

The housing cover 250 may include a plurality of fixing projections 260 for fixing the above-described wire seal 200 on an internal surface thereof.

The charging module 300 includes a pair of temperature sensors connected to sensor cable 310.

The charging module 300 includes a pair of terminal connection portions 330 to which the pair of fast charging cables 360 and the pair of slow charging cables 390 are connected.

One of the pair of terminal connection portions 330 includes a fast charging terminal 340 to which the fast charging cable 360 is connected and a slow charging terminal 390 to which the slow charging cable 390 is connected and which is coupled to an upper portion of the fast charging terminal 340.

The fast charging cable 360 includes a first welding portion 370, which is bonded to the fast charging terminal 340, at an end portion thereof. The first welding portion 370 may be bonded to the fast charging terminal 340 through ultrasonic waves.

The slow charging cable 390 includes a second ultrasonic bonding portion 400, which is bonded to the slow charging terminal 390, at an end portion thereof. The second ultrasonic bonding portion 400 may be bonded to the slow charging terminal 390 through ultrasonic waves.

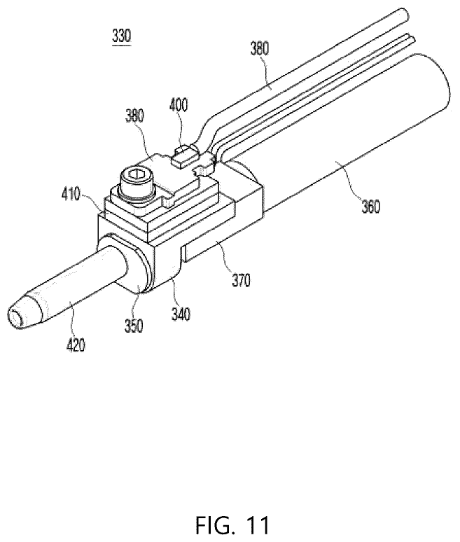

Depending on embodiments, as illustrated in FIG. 11, the pair of terminal connection portions 330 may further include a voltage sensor 410 disposed between the fast charging terminal 340 and the slow charging terminal 390.

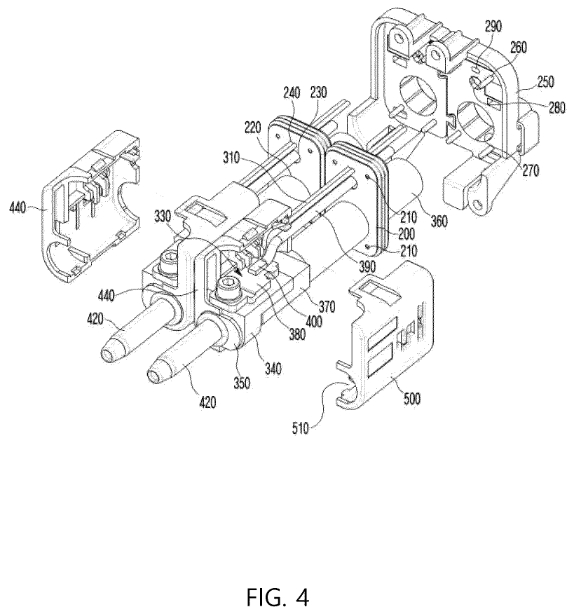

As illustrated in FIG. 3 and FIG. 4, the fast charging terminal 340 and the slow charging terminal 390 may be connected through bolts.

The pair of terminal connection portions 330 includes a pair of charging terminals 420 including at least a portion exposed to the coupling portion 110.

The pair of terminal connection portions 330 includes a pair of stepped portions 350 each including an elliptical shape and protruding in a longitudinal direction to be accommodated on a first support portion 470.

The pair of charging terminals 420 protrude in front of the fast charging terminal 340 in a longitudinal direction thereof.

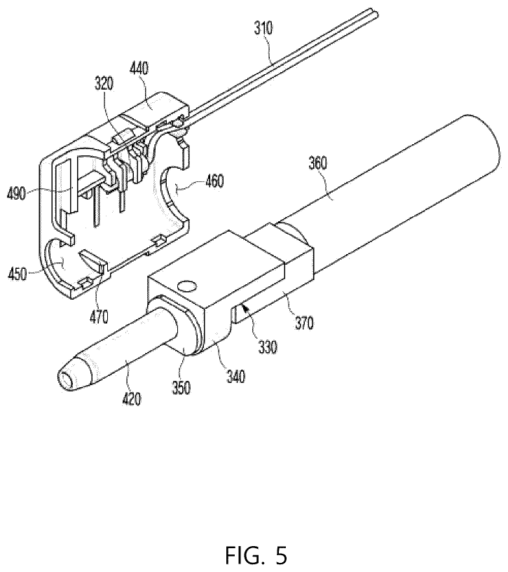

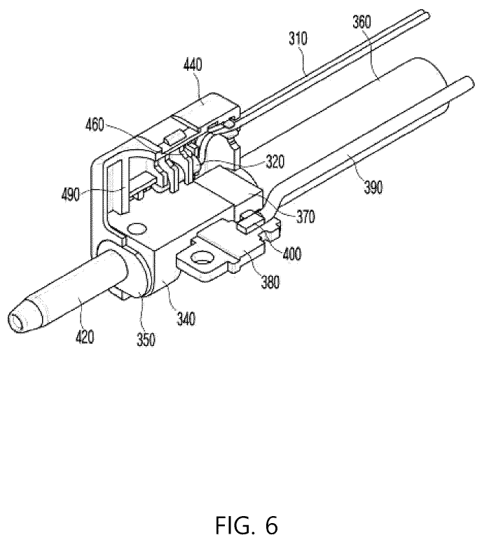

As illustrated in FIG. 4, FIG. 5 and FIG. 6, the pair of charging terminals 420 protrude from the above-described pair of stepped portions 350 in the longitudinal direction.

The charging module 300 further includes a pair of terminal holder covers 430 that fix the pair of fast charging terminals 340.

At least one of the pair of terminal holder covers 430 includes a first cover portion 440 and a second cover portion 500.

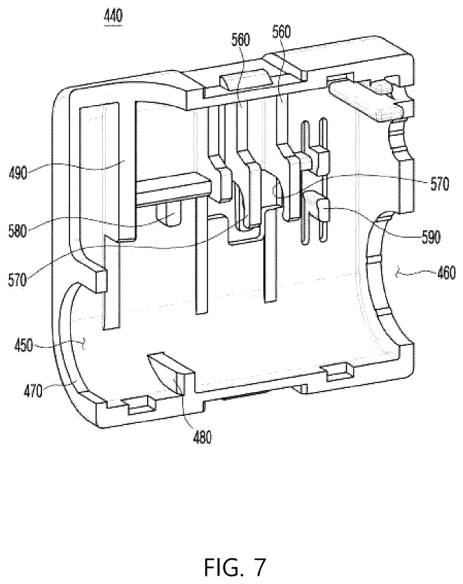

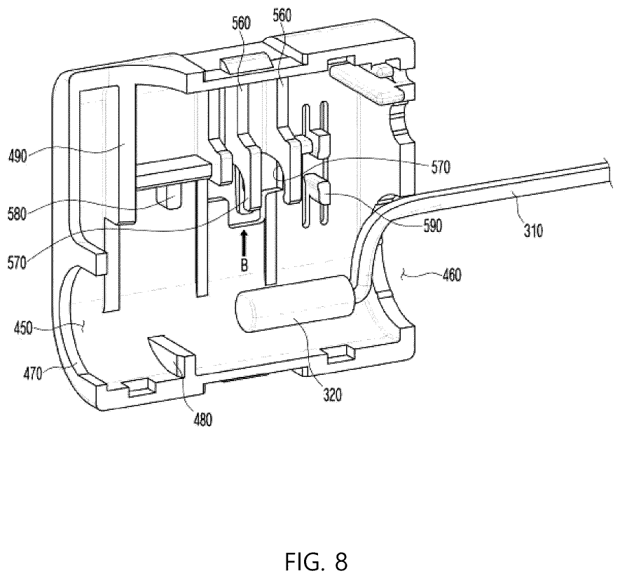

Referring to FIGS. 7 and 8, the first cover portion 440 includes a first installation hole 450 in which at least a portion of the charging terminal 420 is provided on one side of an internal surface in the longitudinal direction. A half of the terminal connection portions 330 may be coupled to the first installation hole 450 in the first cover portion 440.

The first cover portion 440 includes a second installation hole 460 in which at least a portion of the fast charging cable 360 is provided on the other side thereof. A half of the fast charging cable 360 may be coupled to the second installation hole 460 in the first cover portion 440.

Referring to FIGS. 7 and 8, the first cover portion 440 includes a first support portion 470 formed at a circumference of the first installation hole while protruding inward in a radial direction thereof. At least a portion of the stepped portion 350 formed on the above-described terminal connection portion 330 is coupled to the first support portion 470.

Since the stepped portion 350 includes an elliptical shape with straight upper and lower portions, the stepped portion 350 may prevent the terminal connection portion 330 from rotating in the terminal holder cover 430.

The first cover portion 440 includes a first stopper 480 which is spaced apart from the first support portion 470 in the longitudinal direction and supports a rear portion of the terminal connection portion 330. The first stopper 480 may prevent the charging terminal 420 from being pushed in a longitudinal direction of the charging terminal 420 when the charging connector is coupled to the charging terminal 420.

Referring to FIG. 8, the first cover portion 440 includes a first protruding portion 490 that supports a top surface of the terminal connection portion 330.

The first cover portion 440 further includes a sensor fixing portion in which the temperature sensor 320 is provided on an internal surface thereof.

The sensor fixing portion includes a third protruding portion 560 that extends from the internal surface of the first cover portion 440 and includes a sensor fixing groove 570 at a lower portion thereof.

Also, the first cover portion 440 includes a first sensor stopper 580 formed on the internal surface to support one side in a longitudinal direction of the temperature sensor 320.

The first cover portion 440 includes a second sensor stopper 590 formed on the internal surface to support the other side in the longitudinal direction of the temperature sensor 320.

As illustrated in FIG. 8, the temperature sensor may be coupled in an upward direction B from therebelow when provided in the sensor fixing groove 570.

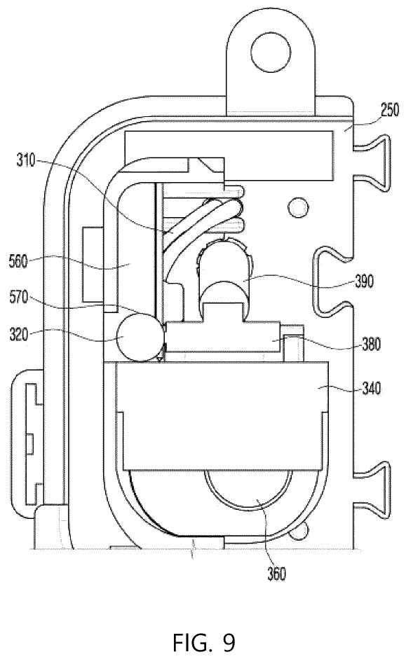

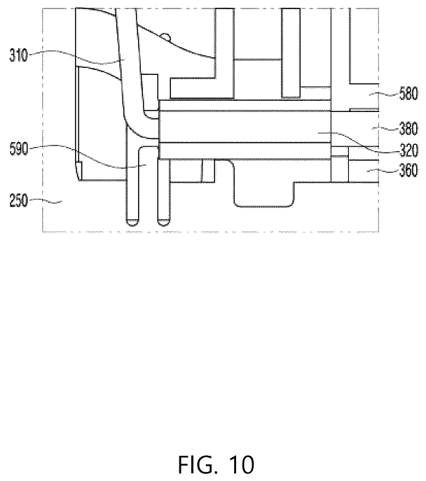

As illustrated in FIG. 9 and FIG. 10, the temperature sensor is provided in the sensor fixing groove 570 to contact with a top surface of the fast charging terminal 340 and a side surface of the slow charging terminal 390.

Also, the temperature sensor may be supported by the fast charging terminal 340 coupled to the first cover portion 440 to prevent the temperature sensor from being separated downward in a state of being coupled to the sensor fixing groove 570.

The second cover portion 500 includes a third installation hole in which at least a portion of the charging terminal 420 is provided on one side of an internal surface in a longitudinal direction thereof. A half of the terminal connection portion 330 may be coupled to the third installation hole in the second cover portion 500.

The second cover portion 500 includes a fourth installation hole in which at least a portion of the fast charging cable 360 is provided on the other side thereof. A half of the fast-charging cable 360 may be coupled to the fourth installation hole in the second cover portion 500.

The second cover portion 500 includes a second support portion formed at a circumference of the third installation hole while protruding inward in a radial direction thereof. At least a portion of the stepped portion 350 formed on the above-described terminal connection portion 330 is coupled to the second support portion.

The second cover portion 500 further includes a second stopper which is spaced apart from the second support portion in a longitudinal direction thereof to support the rear portion of the terminal connection portion 330. The second stopper may prevent the charging terminal 420 from being pushed in the longitudinal direction of the charging terminal 420 when the charging connector is coupled to the charging terminal 420.

The second cover portion 500 includes a second protruding portion that supports the top surface of the terminal connection portion 330.

Since the second cover portion 500 includes the same internal shape as that of each of rest components of the above-described first cover portion 440 except for the third protruding portion 560, the first sensor stopper 580, and the second sensor stopper 590, a detailed description thereof will be omitted.

The present disclosure may exhibit an effect of distributing fast/slow power without the fast/slow distribution junction block.

Since the present disclosure distributes the fast/slow power in the inlet device, the fast/slow distribution junction block is not required. Thus, the present disclosure may exhibit an effect of reducing the weight of the vehicle, securing the internal space of the vehicle, and saving the costs, which increase when the fast/slow distribution junction block is applied.

Also, since the present disclosure may reduce the number of processes for vehicle component assembly, the productivity increase may be also expected.

Technical objects to be solved by the present disclosure are not limited to the aforementioned technical objects and unmentioned technical objects will be clearly understood by those skilled in the art to which the present disclosure belongs.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively. ” The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a predetermined condition is satisfied, to perform the related operation or interpret the related definition according to the predetermined condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An inlet apparatus for an electric vehicle, the inlet apparatus comprising:
a housing including a coupling portion to which a charging connector is coupled;
a charging module including a pair of temperature sensors each connected to a sensor cable, a pair of terminal connection portions each connected to a fast charging cable and a slow charging cable, and a pair of charging terminals respectively connected to the pair of terminal connection portions and exposed through the coupling portion;
a signal module including a plurality of signal terminals exposed through the coupling portion so that the vehicle exchanges signals with the charging connector; and
a locking actuator configured to selectively lock the charging connector coupled to the coupling portion.

2. The inlet apparatus of claim 1, wherein each of the pair of terminal connection portions includes:
a fast charging terminal connected to the fast charging cable; and
a slow charging terminal connected to the slow charging cable.

3. The inlet apparatus of claim 2,
wherein the fast charging cable includes a first welding portion fixed to the fast charging terminal by a ultrasonic welding process, and
wherein the slow charging cable includes a second welding portion fixed to the slow charging terminal by a ultrasonic welding process.

4. The inlet apparatus of claim 2, further including a voltage sensor disposed between the fast charging terminal and the slow charging terminal.

5. The inlet apparatus of claim 2, wherein the fast charging terminal and the slow charging terminal are coupled through a bolt.

6. The inlet apparatus of claim 2, wherein the charging module further includes a pair of terminal holder covers respectively fixing the pair of fast charging terminals.

7. The inlet apparatus of claim 6, wherein each of the pair of terminal holder covers includes:
a first cover portion including:
a first installation hole, in which at least a portion of the charging terminals is provided, at one side of an internal surface in a longitudinal direction thereof; and
a second installation hole, in which at least a portion of the fast charging cable is provided, at another side of the internal surface.

8. The inlet apparatus of claim 6, wherein each of the pair of terminal holder covers includes:
a second cover portion including:
a third installation hole, in which at least a portion of the charging terminals is provided, at one side of an internal surface in a longitudinal direction thereof; and
a fourth installation hole, in which at least a portion of the fast charging cable is provided, at another side of the internal surface.

9. The inlet apparatus of claim 7,
wherein the first cover portion includes:
a first support portion formed on a circumference of the first installation hole while protruding inward in a radial direction thereof;
a first stopper spaced apart from the first support portion in the longitudinal direction to support a rear portion of the terminal connection portions; and
a first protruding portion configured to support a top surface of the terminal connection portions.

10. The inlet apparatus of claim 7,
wherein the second cover portion includes:
a second support portion formed on a circumference of the third installation hole while protruding inward in a radial direction thereof;
a second stopper spaced apart from the second support portion in the longitudinal direction to support the rear portion of the terminal connection portions; and
a second protruding portion configured to support a top surface of the terminal connection portions.

11. The inlet apparatus of claim 9,
wherein each of the pair of terminal connection portions includes a stepped portion including a shape of a circle and protruding in the longitudinal direction to be accommodated on the first support portion, and
wherein each of the pair of charging terminal protrudes from the stepped portion in the longitudinal direction.

12. The inlet apparatus of claim 7, wherein the first cover portion further includes a sensor fixing portion in which the temperature sensors are provided.

13. The inlet apparatus of claim 12, wherein the sensor fixing portion includes a third protruding portion that protrudes from the internal surface of the first cover portion and includes a sensor fixing groove at a lower portion thereof.

14. The inlet apparatus of claim 13, wherein the temperature sensors are provided in the sensor fixing groove to contact with a top surface of the fast charging terminal and a side surface of the slow charging terminal.

15. The inlet apparatus of claim 1, wherein the housing includes:
a housing main body on which the charging module and the signal module are provided;
a housing cover coupled to a rear portion of the housing main body; and
a wire seal disposed between the housing main body and the housing cover.

16. The inlet apparatus of claim 15, wherein the wire seal includes:
a pair of first fast charging cable holes through which the fast charging cable passes;
a pair of first slow charging cable holes through which the slow charging cable passes; and
a first sensor cable hole through which the sensor cable passes.

17. The inlet apparatus of claim 15, wherein the housing cover includes:
a pair of second fast charging cable holes through which the fast charging cable passes;
a pair of second slow charging cable holes through which the slow charging cable passes; and
a second sensor cable hole through which the sensor cable passes.

18. The inlet apparatus of claim 1,
wherein the housing includes a locking actuator installation portion formed at a lower portion thereof, and
wherein the locking actuator installation portion includes a locking pole installation portion that communicates with the coupling portion.

19. The inlet apparatus of claim 18, wherein the locking actuator installation portion includes:
a drain seal formed at one side; and
a drain seal cover that covers the drain seal.
